(19) United States
(12) Patent Application Publication
(10) Pub. No.: US 2015/0283511 A1
(43) Pub. Date: Oct. 8, 2015

(54) METHOD AND DEVICE FOR DESALTING AQUEOUS SOLUTIONS BY MEANS OF ELECTRODIALYSIS

(71) Applicant: FRAUNHOFER-GESELLSCHAFT ZUR FÖRDERUNG DER ANGEWANDTEN FORSCHUNG, München (DE)

(72) Inventors: Siegfried Egner, Adelsheim (DE); Alexander Karos, Norderstedt (DE); Eberhard Winkler, Dresden (DE); Hans-Juergen Foerster, Bitterfeld (DE)

(21) Appl. No.: 14/439,101

(22) PCT Filed: Nov. 6, 2013
(86) PCT No.: PCT/EP2013/073131

§ 371 Date: Apr. 28, 2015

(30) Foreign Application Priority Data
Nov. 15, 2012 (DE) 10 2012 220 908.5

(51) Int. Cl. B01D 61/42

(52) U.S. Cl. CPC B01D 61/422

(57) ABSTRACT

In a method for desalting aqueous solutions by means of electrodialysis in an electrochemical cell (10) comprising a first electrode (16) and a second electrode (20), wherein the second electrode (20) has a polarity opposite to the first electrode and wherein at the first electrode (16) an electrolysis gas and ions are formed, it is proposed that the electrolysis gas and the ions are reacted at the second electrode (20).

The invention relates to a method and device for desalting aqueous solutions by means of electrodialysis.

In industrial production or cleaning aqueous solutions such as acids and bases are used. To be able to dispose of these acidic or basic aqueous solutions, they must first be neutralized. This ensures safe handling and statutory guidelines for introducing liquids into the sewer system are observed.

Usually the neutralization of the acidic or basic aqueous solutions is performed by addition of bases or acids, which have a corresponding pH-value, so that a mixture with a largely neutral pH forms.

The acids or bases added are being consumed and are no longer available for other applications. The acids or bases added represent a significant cost factor.

The resulting neutral solution has a high salt load and can be used only conditionally, because the salt load is accumulated by recirculation, which increases the conductivity of the aqueous solution. This is associated with problems such as increased corrosiveness of the solution or mineral deposits on parts.

So far, the neutralized solutions were disposed of via the wastewater network and are therefore lost for further utilization.

It is known to remove or to separate the salt load of aqueous solutions using electrodialysis, and transform them into acids and bases. In this case, a part of the electrical energy required for the electrodialysis goes because, according to the prior art, electrolysis gases form at the electrodes of an electrochemical cell.

The formation of electrolysis gases requires a so-called overvoltage at the electrodes. The electrolysis gas escapes from the cell without being used or is converted into electricity separately in a downstream fuel cell (see US 2007/008 47 28 A1). This portion of the energy is no longer available for the separation of the salt solution. Therefore, the efficiency and thus the economic viability of electrodialysis systems are low.

From DE 42 31 028 A1, a method is known for the treatment aqueous liquids obtained in the surface treatment of waste water.

From DE 43 10 365 C1, a method is known where aqueous etching baths of metals are regenerated by means of electrodialysis.

The present invention provides a method and device that increase the efficiency of the electrodialysis, thus ensuring better utilization of the electrical energy used for this purpose. A basic idea of the invention is to react the electrolysis gas formed at a first electrode in an electrochemical cell directly at a second electrode of the electrochemical cell. The electrolysis gases formed are usually elemental oxygen (O₂) and elemental hydrogen (H₂). With the oxygen being formed at a positive electrode, the anode, and hydrogen being formed at a negative electrode, the cathode.

As a result, there are two embodiments of the method according to the invention:

In a first embodiment, at the first electrode (anode) which is arranged in a first electrode chamber of the electrochemical cell and which is supplied with a basic electrolyte solution, for example sodium hydroxide solution, oxygen is formed according to the following equation:

2H₂O=>O₂+4H⁺+4e⁻ Equation (1)

The oxygen (O₂) together with the aqueous electrolyte, which is added to the first electrode chamber are conveyed into a second electrode chamber. The ions that formed, in this first embodiment these are protons (H⁺) reach through a membrane stack which separates the first electrode chamber from the second electrode chamber, into the second electrode chamber.

The membrane stack consists of a plurality of ion-exchange membranes and is suitable to remove the ionic constituents from the aqueous solution to be desalted and to sort them according to their charge.

At a second electrode (cathode) which is arranged in the second electrode chamber, an electrochemical reaction takes place according to the following equation:

O₂+4H⁺+4e⁻=>2H₂O Equation (2)

Thus, the electrolysis gas (oxygen) that formed at the first electrode (anode) and the ions (H⁺) at the second electrode (cathode) are reacted substantially completely with formation of water (H₂O).

The pH values of the electrolyte solution and the standard potentials of the reactants are approximately equal in size in the first electrode chamber (anode chamber) and in the second electrode chamber (cathode chamber).

The direct current voltage to be applied is the aggregate of the contributions of anodic overvoltage, cathodic overvoltage and the voltage drop across the membrane stack.

The electrical energy to be applied is lower than that of a combination of an electrodialysis cell with a downstream fuel cell.

To substantially completely react the gaseous oxygen contained in the aqueous electrolyte at the cathode (second electrode) with formation of water, it is necessary that the surface of the cathode is as large as possible.

The cathode is made for example of nickel foam or platinum-plated nickel foam.

In a second embodiment, at the first electrode (cathode) which is arranged in a first electrode chamber of the electrochemical cell and which is supplied with a basic electrolyte solution, for example sodium hydroxide solution, hydrogen is formed according to the following equation:

2H₂O+2e⁻=>H₂+2OH⁻ Equation (3)

The hydrogen (H₂) together with the aqueous electrolyte, which is added to the first electrode chamber are conveyed into a second electrode chamber. The ions that formed, in this second embodiment these are hydroxide ions (OH⁻) reach through a membrane stack which separates the first electrode chamber from the second electrode chamber, into the second electrode chamber.

The membrane stack consists of a plurality of ion-exchange membranes and is suitable to remove the ionic constituents from the aqueous solution to be desalted and to sort them according to their charge.

At a second electrode (anode) which is arranged in the second electrode chamber, an electrochemical reaction takes place according to the following equation:

H₂+2OH⁻=>2H₂O+2e⁻ Equation (4)

Thus, the electrolysis gas (hydrogen) that formed at the first electrode (cathode) and the ions (OH⁻) at the second electrode (anode) are reacted substantially completely with formation of water (H₂O).

The pH values of the electrolyte solution and the standard potentials of the reactants are approximately equal in size in the first electrode chamber (cathode chamber) and in the second electrode chamber (anode chamber).

The direct current voltage to be applied is the aggregate of the contributions of anodic overvoltage, cathodic overvoltage and the voltage drop across the membrane stack. The anodic overvoltage and the cathodic overvoltage at the electrodes are not larger than the one that would occur in a separate fuel cell.

The electrical energy to be applied is lower than that of a combination of an electrodialysis cell with a downstream fuel cell.

To substantially completely react the gaseous hydrogen contained in the aqueous electrolyte at the anode (second electrode) with formation of water, it is necessary that the surface of the anode is as large as possible.

The anode is made for example of nickel foam or platinum-plated nickel foam.

Furthermore, a device is proposed which is suitable to perform the method according to the invention in its first or second embodiment.

Further features, application possibilities and advantages of the invention will become apparent from the following description of exemplary embodiments of the invention, which are illustrated in the figures of the drawing. All the features, alone or in any combination, described or illustrated are the subject of the invention, regardless of their combination in the claims or their dependencies and irrespective of their wording or representation in the description or in the drawing.

In the drawings:

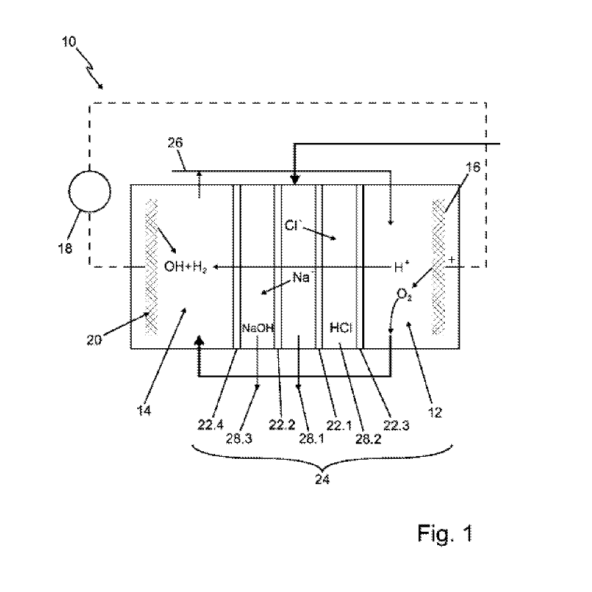

FIG. 1 shows an electrochemical cell for performing a first embodiment of the method according to the invention;

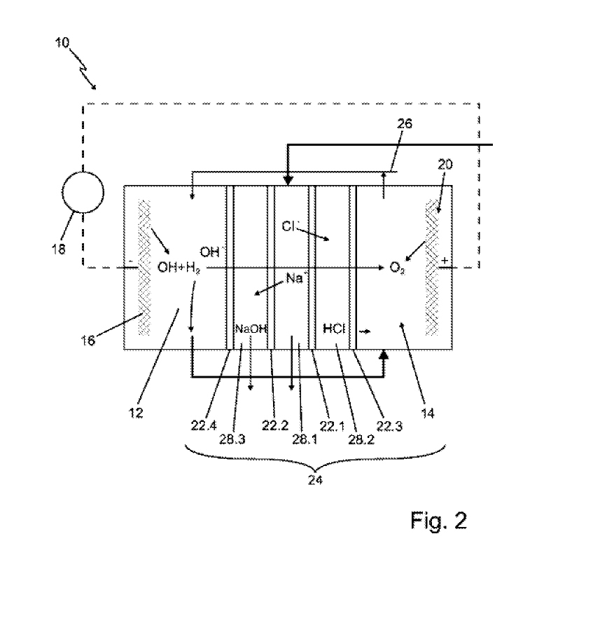

FIG. 2 shows an electrochemical cell for performing a second embodiment of the method according to the invention;

For functionally equivalent elements and sizes in all the figures the same reference numerals are used, even with different embodiments.

FIG. 1 shows a schematic representation of an electrochemical cell 10. The electrochemical cell 10 comprises a first electrode chamber 12 and a second electrode chamber 14. A first electrode 16 is arranged in the first electrode chamber 14. The first electrode 16 is electrically connected with a second electrode 20 via an electric direct current voltage source 18.

The second electrode 20 is arranged in the second electrode chamber 14. The second electrode chamber 14 is spatially separated from the first electrode 12 by a membrane stack 24 comprising a plurality of membranes 22. An aqueous electrolyte solution flows through both electrode chambers 12,14. For this, the electrolyte solution is supplied to the first electrode chamber 12 in order to be conveyed from there into the second electrode chamber 14.

The electrolyte solution is conveyed back into the first electrode chamber 12 from the second electrode chamber 14. A branch 26 provides the possibility to replace spent electrolyte solution.

The membranes 22 in the membrane stack 24 are spaced from each other so that channels 28 form between two adjacent membranes. A central channel 28.1 is adapted to be supplied with an aqueous solution to be desalted, for example, with a sodium chloride solution.

If the direct current power source 18 is switched so that the first electrode 16 has a positive polarity (anode) and the second electrode 20 has a negative polarity (cathode), anions contained in the aqueous solution, for example Cl⁻, migrate from the central channel 28.1 through membrane 22.1 toward the first electrode 16 with positive polarity.

The anions are retained by membrane 22.3 in a channel 28.2, which is formed between the membrane 22.1, and the membrane 22.3 and are removed from there together with protons (H⁺) as an acid, in this application example, as hydrochloric acid.

The cations present in the aqueous solution, for example Na⁺, however, migrate through the membrane 22.2 toward the second electrode 20 with negative polarity. The cations are retained by membrane 22.4 in a channel 28.3, which is formed between the membrane 22.2, and the membrane 22.4 and are removed from there together with hydroxide ions (OH⁻) as a base, in this application example, as aqueous sodium hydroxide solution.

Following the diffusion of the ions contained in the aqueous solution to be desalted through the membranes 22 into adjacent channels 28.2 or 28.3, desalted liquid, here for example water, can be withdrawn from the central channel 28.1.

The electrical voltage applied between the electrodes 16, 20 also causes the following electrolytic reaction to take place at the positive first electrode 16:

2H₂O=>O₂+4H⁺+4e⁻ Equation (1)

The protons H⁺ formed as ions migrate through the membrane stack 24 to the negative second electrode 20.

The elemental oxygen (O₂) formed as electrolysis gas together with the cleaning solution from the first electrode chamber 12 are conveyed into the second electrode chamber 14. Thus, at the negative second electrode 20 arranged there, the following reaction can take place:

O₂+4H⁺+4e⁻=>2H₂O Equation (2)

The electrolysis gas (elemental oxygen, O₂) is reacted in the second electrode chamber 14 with the ion (proton, H⁺) formed at the positive first electrode with acceptance of electrons (e⁻) to form water (H₂O).

In order for the electrolysis gas contained in the cleaning solution to be reacted as completely as possible, it is preferred to employ a second electrode 20 the surface of which is as large as possible.

A possible electrode material for the second electrode 20 is nickel foam which can also be provided with platinum.

The pH values in the first electrode chamber and in the second electrode chamber are approximately equal.

FIG. 2 shows the electrochemical cell 10 of FIG. 1. In contrast to FIG. 1, here the direct current voltage source 18 is switched so that the first electrode 16 has a negative polarity and the second electrode 20 has a positive polarity.

The electrical voltage applied causes in the first electrode chamber 14 at the negatively charged first electrode the water of the basic electrolyte contained therein to dissociate as follows:

2H₂O+2e⁻=>H₂+2OH⁻ Equation (3)

In the illustrated second embodiment of the method according to the invention, the electrolysis gas formed is elemental hydrogen (H₂) which together with the aqueous electrolyte is conveyed into the second electrode chamber. The ions (hydroxide ions, OH⁻) formed the first electrode chamber migrate through the membrane stack to the positive second electrode 20.

Benefiting from the basic electrolyte solution, the following reaction takes place at the positive second electrode 20:

H₂+2OH⁻=>2H₂O+2e⁻ Equation (4)

The electrolysis gas (elemental hydrogen, H₂) is reacted in the second electrode chamber 14 with the ion (hydroxide ion, OH⁻) formed at the negative first electrode 16 with loss of electrons (e⁻) to form water (H₂O).

In order for the electrolysis gas contained in the cleaning solution to be reacted as completely as possible, it is preferred to employ a second electrode 20 the surface of which is as large as possible.

A possible electrode material for the second electrode 20 is nickel foam which can also be provided with platinum.

The pH values in the first electrode chamber and in the second electrode chamber are approximately equal.

1. A method for desalting aqueous solutions by means of electrodialysis in an electrochemical cell (10) comprising a first electrode (16) and a second electrode (20), the second electrode (20) having a polarity opposite to the first electrode (16), wherein at the first electrode (16) an electrolysis gas and ions are formed, characterized in that the method comprises reacting the electrolysis gas and the ions at the second electrode (20).

2. The method according to claim 1, characterized in that the electrolysis gas is conveyed with an aqueous electrolyte solution from a first electrode chamber (12) to a second electrode chamber (14).

3. The method according to claim 1, characterized in that the ions formed at the first electrode (16) reach through a membrane stack (24) of the electrochemical cell (10) from a first electrode chamber (12) into a second electrode chamber (14).

4. The method according to claim 1, characterized in that the electrolysis gas formed at the first electrode (16) comprises elemental oxygen (O₂), and the ions comprise protons (H⁺).

5. The method according to claim 1, characterized in that the electrolysis gas formed at the first electrode (16) comprises elemental hydrogen (H₂), and the ions comprise hydroxide ions (OH⁻).

6. A device for desalting aqueous solutions by means of electrodialysis using the method according to claim 1, the device having the electrochemical cell (10) with a first electrode chamber (12) and a second electrode chamber (14), the first electrode chamber (12) being separated from the second electrode chamber (14) by a membrane stack (24), the first electrode (16) being arranged in the first electrode chamber (12), the second electrode (20) being arranged in the second electrode chamber (14), and the two electrodes having opposite polarity, characterized in that the device comprises means to convey an aqueous electrolyte solution which is supplied to the first electrode chamber (12) together with the electrolysis gas formed at the first electrode (16) from the first electrode chamber (12) into the second electrode chamber (14).

7. The device according to claim 6, characterized in that
the membrane stack (24) comprises four membranes (22.1 to 22.4),
a first membrane (22.1) and a second membrane (22.2) define a central channel (28.1),
a third membrane (22.3) is arranged between the first membrane (22.1) and the first electrode (16), and
a fourth membrane (22.4) is arranged between the second membrane (22.2) and the second electrode (20).

8. The device according to claim 6, characterized in that the device comprises means to convey the aqueous electrolyte solution from the second electrode chamber (14) into the first electrode chamber (12).

9. The device according to claim 6, characterized in that the membrane stack (24) is permeable to the ions formed at the first electrode (16).

10. The device according to claim 7, characterized in that the device comprises means to convey the aqueous electrolyte solution from the second electrode chamber (14) into the first electrode chamber (12).

11. The device according to claim 7, characterized in that the membrane stack (24) is permeable to the ions formed at the first electrode (16).

12. The device according to claim 8, characterized in that the membrane stack (24) is permeable to the ions formed at the first electrode (16).

13. The method according to claim 2, characterized in that the ions formed at the first electrode (16) reach through a membrane stack (24) of the electrochemical cell (10) from the first electrode chamber (12) into the second electrode chamber (14).

14. The method according to claim 2, characterized in that the electrolysis gas formed at the first electrode (16) comprises elemental oxygen (O₂) and the ions comprise protons (H⁺).

15. The method according to claim 2, characterized in that the electrolysis gas formed at the first electrode (16) comprises elemental hydrogen (H₂), and the ions comprise hydroxide ions (OH⁻).

16. The method according to claim 3, characterized in that the electrolysis gas formed at the first electrode (16) comprises elemental oxygen (O₂) and the ions comprise protons (H⁺).

17. The method according to claim 3, characterized in that the electrolysis gas formed at the first electrode (16) comprises elemental hydrogen (H₂), and the ions comprise hydroxide ions (OH⁻).

18. The method according to claim 4, characterized in that the electrolysis gas formed at the first electrode (16) comprises elemental hydrogen (H₂), and the ions comprise hydroxide ions (OH⁻).

19. A device for desalting aqueous solutions by means of electrodialysis, comprising a electrochemical cell (10) having a first electrode chamber (12) and a second electrode chamber (14), the first electrode chamber (12) being separated from the second electrode chamber (14) by a membrane stack (24), a first electrode (16) being arranged in the first electrode chamber (12), a second electrode (20) being arranged in the second electrode chamber (14), the two electrodes having opposite polarity, characterized in that the device comprises means to convey an aqueous electrolyte solution which is supplied to the first electrode chamber (12) together with electrolysis gas formed at the first electrode (16) from the first electrode chamber (12) into the second electrode chamber (14).

20. The device according to claim 19, characterized in that
the membrane stack (24) comprises four membranes (22.1 to 22.4),
a first membrane (22.1) and a second membrane (22.2) define a central channel (28.1),
a third membrane (22.3) is arranged between the first membrane (22.1) and the first electrode (16), and
a fourth membrane (22.4) is arranged between the second membrane (22.2) and the second electrode (20).

21. The device according to claim 19, characterized in that
the device comprises means to convey the aqueous electrolyte solution from the second electrode chamber (14) into the first electrode chamber (12), and/or
the membrane stack (24) is permeable to the ions formed at the first electrode (16).
